(19) United States
(12) Patent Application Publication
(10) Pub. No.: US 2014/0201231 A1
(43) Pub. Date: Jul. 17, 2014

(54) Social Knowledge Search

(71) Applicant: MICROSOFT CORPORATION, Redmond, WA (US)

(72) Inventors: Charles Keller Smith, Seattle, WA (US); Duane Stanley Bolick, JR., Duvall, WA (US); Andrew Joseph Violino, Santa Monica, CA (US); Glen Howard Anderson, Woodinville, WA (US); Yoo Mi Lee, Seattle, WA (US)

(73) Assignee: Microsoft Corporation, Redmond, WA (US)

(21) Appl. No.: 13/738,995

(22) Filed: Jan. 11, 2013

(51) Int. Cl. G06F 17/30

(52) U.S. Cl. CPC G06F 17/30864
USPC 707/769

(57) ABSTRACT

A social collaboration search tool provides a mechanism for collaborators within an organization to search for and retrieve conversations that include social knowledge interactions. The social collaboration search tool may also provide additional social information to the searcher. The social knowledge interactions search tool can provide a mechanism by which these interactions are indexed and surfaced in a first class search vertical with specialized display formats that may enable the searcher to efficiently retrieve and use the most important or relevant information.

### BACKGROUND

Business knowledge within an organization can be generated in various ways. For example, business knowledge can be generated organically by employees simply doing the tasks associated with their work. Business knowledge within an organization can also be generated by the introduction of knowledge from outside sources, either through hiring people with special skill sets or training current employees to increase their skill sets. Another way that business knowledge can be generated within an organization is through the interaction of employees. For example, employees may work collectively in a group to solve problems or enhance products or services.

By working together in groups, the increase in knowledge may be greater than what any one individual may be able achieve on their own, and, may be of a higher quality because of the collective review of the business knowledge. Although it can be called several things, some organizations refer to the interaction between employees (and in some cases, individuals or groups outside of the organization) as social knowledge interactions. Social knowledge interactions may take many forms and can be implemented in various ways. The interactions between employees often contain critical business value and knowledge. However, this kind of knowledge can be difficult to locate.

It is with respect to these and other considerations that the disclosure made herein is presented.

### SUMMARY

Concepts and technologies are described herein for a social collaboration search tool for searching social knowledge interactions, such as those generated in an enterprise. In accordance with some concepts and technologies disclosed herein, the social collaboration search tool can provide a way for collaborators within an organization to search for and retrieve social knowledge interactions. The social collaboration search tool may also display additional social information. In some examples, the social collaboration search tool can provide indexing for search results and surface the search results in a first class search vertical with specialized display formats that may enable the searcher to efficiently retrieve and use the most important or relevant information.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram showing an illustrative operating environment that may be used to implement various embodiments disclosed herein.

FIG. 2 is a user interface (“UI”) diagram showing various UIs that may be presented for searching and displaying social knowledge interactions, in accordance with some embodiments.

FIG. 3 is a UI diagram showing a global conversations search, in accordance with some embodiments.

FIG. 4 is a UI diagram showing search results using a search filter, in accordance with some embodiments.

FIG. 5 is a UI diagram showing search results associated with an individual, in accordance with some embodiments.

FIG. 6 is a UI diagram showing search results that are specific to an individual, in accordance with some embodiments.

FIG. 7 is a UI diagram showing a conversation specific search, in accordance with some embodiments.

FIG. 8 is a block diagram illustrating an exemplary method for a server-side collaboration application providing a social collaboration search tool, in accordance with some embodiments.

FIG. 9 is a block diagram illustrating an exemplary method for a client-side collaboration application providing a social collaboration search tool, in accordance with some embodiments.

FIG. 10 is a computer architecture diagram showing an illustrative computer hardware and software architecture for a computing system capable of implementing aspects of the embodiments presented herein.

FIG. 11 is a diagram illustrating a distributed computing environment capable of implementing aspects of the embodiments presented herein.

FIG. 12 is a computer architecture diagram illustrating a computing device architecture capable of implementing aspects of the embodiments presented herein.

### DETAILED DESCRIPTION

The following detailed description is directed to a social collaboration search tool used, in some examples, in conjunction with an enterprise collaboration environment. In accordance with some concepts and technologies disclosed herein, the social collaboration search tool provides a way for collaborators to search for and retrieve social knowledge interactions. In some configurations, the social collaboration search tool can index and surface in a first class search vertical specialized display formats that may enable the user to efficiently retrieve and use certain information.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodologies for a social collaboration search tool and other aspects will be presented.

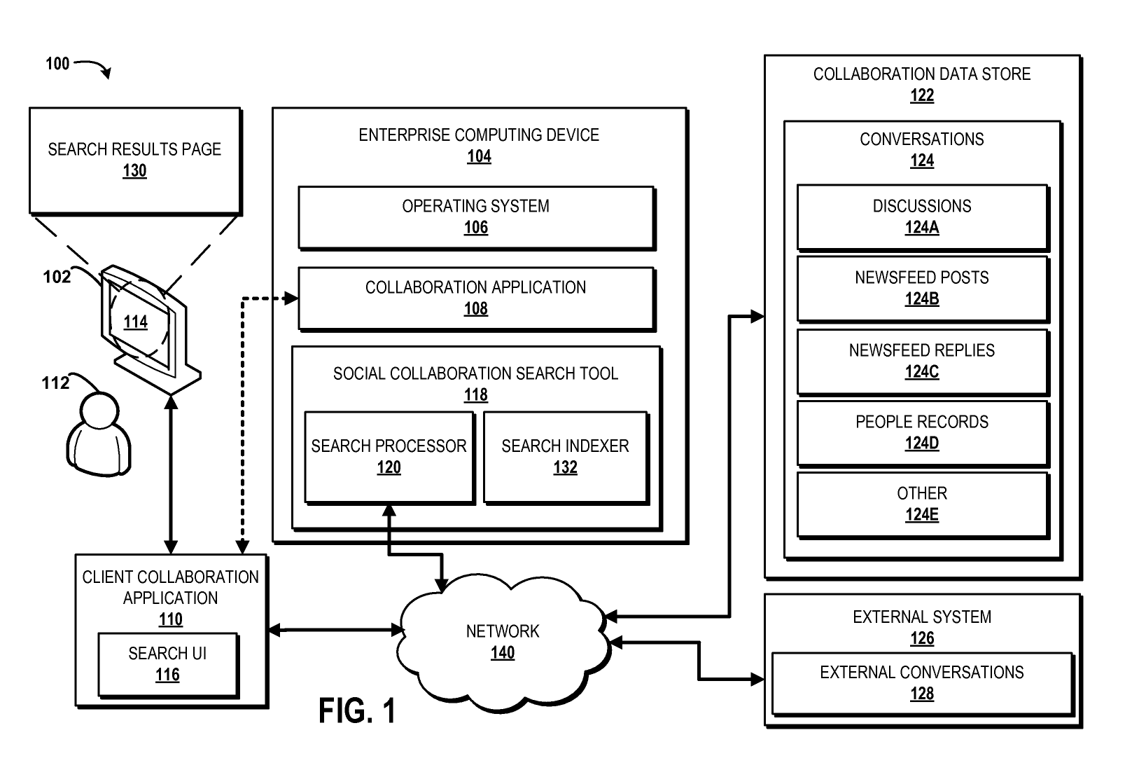

Referring now to FIG. 1, aspects of an operating environment 100 for the various embodiments presented herein will be described. The operating environment 100 shown in FIG. 1 includes a client device 102 operating on or in communication with an enterprise computing device 104 through a network 140. In some embodiments, the client device 102 and/or the enterprise computing device 104 can include a desktop computer, a laptop computer, a notebook computer, an ultra-portable computer, a netbook computer, or a computing device such as a mobile telephone, a tablet device, a slate device, a portable video game device, or the like.

In some configurations, the client device 102 and the enterprise computing device 104 can operate in a client-server configuration. As used herein, a “client-server” configuration includes a computing system having one or more resource providers (the “server”) that provide resources to one or more resource requestors (the “client”). In the operating environment 100 illustrated in FIG. 1, the client device 102 is described as a client that requests resources through the network 140 from the enterprise computing device 104, which is described as a server. It should be appreciated, however, that the concepts and technologies described herein can be implemented in computing configurations other than a client-server configuration. The operating environment 100 is described herein in terms of a client-server configuration for illustrative purposes only and does not represent an intent to limit the scope of the subject matter disclosed herein. In some configurations, the network 140 can include the Internet, an intranet, or an extranet, or various combinations thereof.

An operating system 106 is executing on the enterprise computing device 104. The operating system 106 is an executable program for controlling various functions on the enterprise computing device 104. The enterprise computing device 104 can execute a collaboration application 108. The collaboration application 108, in some examples, can provide resources to the client device 102 through a client collaboration application 110 executing on the client device 102, represented in FIG. 1 as a dashed line between the client collaboration application 110 and the collaboration application 108.

In some configurations, the client collaboration application 110 can include a web browser application capable of receiving inputs from the client device 102 and providing a display of resources provided by the collaboration application 108. The collaboration application 108 may be configured to provide various types of functionality including, but not limited to, allowing users to create, maintain and present a collaborative environment to share information to create and/or collaborate on documents, work together in online groups, and/or share information within an organization. In some configurations, the collaboration application 108 can include a web-based application configured to provide some or all of the functions described above as a service.

In some configurations, the client device 102 can include a dumb terminal or thin client. As used herein, a “dumb terminal” and/or a “thin client” includes computing devices that utilize one or more resources provided by a server computer. In the configuration illustrated in FIG. 1, the client device 102 receives, and the enterprise computing device 104 provides, resources associated with the collaboration application 108. In this configuration, a user 112 may interface with the collaboration application 108 through the client collaboration application 110. The collaboration application 108 can receive, through the network 140, inputs received by the client collaboration application 110, process the inputs, and provide one or more outputs to the client collaboration application 110 for display on a display 114.

In some embodiments, the collaboration application 108 and/or the client collaboration application 110 may include, but are not limited to, one or more productivity application programs that are part of the MICROSOFT OFFICE family of products from Microsoft Corporation in Redmond, Wash. The examples of the application programs can include a member of, but are not limited, MICROSOFT WORD, MICROSOFT EXCEL, MICROSOFT POWERPOINT, MICROSOFT SHAREPOINT, MICROSOFT ACCESS, MICROSOFT VISIO, or MICROSOFT OUTLOOK families of application programs. In some embodiments, the collaboration application 108 and/or the client collaboration application 110 may include, but are not limited to, one or more productivity application programs that are part of the GOOGLE DOCS or GOOGLE SITES family of products from Google, Inc. in Mountain View, Calif. In the described embodiments, the collaboration application 108 and/or the client collaboration application 110 are described as including the MICROSOFT SHAREPOINT collaboration application program. It should be understood that examples provided herein using the MICROSOFT SHAREPOINT collaboration application are illustrative, and should not be construed as limiting in any way.

As described briefly above, when using the collaboration application 108, the user 112 may want to search for social knowledge interactions. For example, the user 112 may want to search for discussions within certain collaborative groups, discussions on various topics, and the like. In some configurations, a search UI 116 of the client collaboration application 110 can receive as an input one or more search terms. The search terms, along with an instruction to perform the search, are received by the collaboration application 108. The collaboration application 108 provides the search terms to a search processor 120, which executes the search, invoked by a social collaboration search tool 118. The results of the search can be provided to the client collaboration application 110 for display in a search results page 130 on the display 114 of the client device 102. The search processor 120 may execute a search on various data stores, tables, and/or databases storing social knowledge interactions, such as a collaboration data store 122.

The collaboration data store 122 illustrated in FIG. 1 can include one or more tables, data stores, and/or databases containing social knowledge interactions that can be searched by the search processor 120. In one configuration, the collaboration data store 122 can include conversations data store 124. As used herein, a “conversation” includes information relating to various enterprise-wide social interactions. Thus, the conversations data store 124 can include various types of information corresponding to the various social interactions. In one configuration, the conversations data store 124 can include a discussion 124A, newsfeed posts 124B, newsfeed replies 124C, people records 124D and other social knowledge information, illustrated in the collective as other 124E.

In one configuration, the discussion 124A can include a query and one or more responses to the query. For example, a person in an organization may enter a discussion topic, which can be stored as a discussion 124A. In response to the posting of the discussion topic, one or more collaborators may respond to the topic, which can also be stored as a discussion 124A. The stored discussions can be enterprise-wide discussions or discussions within one or more communities of the enterprise. As used herein, a “community” can include a group of individuals having a common interest. For example, a community can include a department in an enterprise. In another example, a community can include a group of individuals formed to solve a problem. In a further example, a community can include a group of individuals designed to perform a certain task. It should be understood that the concepts and technologies disclosed herein are not limited to any type of discussion or community.

As described above, the conversations data store 124 can also include newsfeed posts 124B and newsfeed replies 124C. As used herein, a “newsfeed” is a topic relating to an event. It should be understood that a topic relating to an event may, in some configurations, be a topic relating to a discussion 124A. The presently disclosed subject matter is not limited to any differentiation between a topic for a discussion 124A and a newsfeed post 124B. An individual or other entity, including the user 112, can post a newsfeed post 124B. Replies to the newsfeed post can be stored as newsfeed replies 124C.

The conversations data store 124 can further include people records 124D. In some configurations, people records 124D include information relating to various individuals in an organization. For example, the people records 124D may include profile pictures and contact information to one or more individuals. When executing a search, if a search result is associated with a particular person, the user 112 may be presented with information about the particular person. Various types of information may be associated with a person included in the people records 124D. In some embodiments, the information can include, but is not limited to, the person's profile, contact information, the department the person works in, groups to which the person belongs, replies or questions the person may have asked, topics the person has commented on, etc.

In some configurations, the search processor 120 may also execute searches on an external system 126 in conjunction with, or in lieu of, executing searches on the collaboration data store 122. As used herein, an “external system” includes systems that are not controlled or otherwise maintained by an organization to which the user 112 is associated with. The external system 126 can include one or more websites configured to receive a search. For example, the external system 126 can include a search engine, a website, or an external computing system. It should be appreciated that the collaboration data store 122 and/or the conversations data store 124 (or various components thereof) may be provided by an external system 126. In that configuration, the collaboration data store 122 or the conversations data store 124 can be termed an external system. The concepts and technologies disclosed herein are not limited to any particular external system 126. The external system 126 can include an external conversations data store 128. The external conversations data store 128 can provide information in a manner similar to the collaboration data store 124.

The search processor 120 may execute a search using various searching algorithms. The concepts and technologies disclosed herein are not limited to any particular searching algorithm. For example, the search processor 120 may execute a search on the collaboration data store 122 using search terms entered by the user 112. A search term can include a string of characters relating to a search. The string of characters can include one or more words, phrases, Boolean operators, or filters, as understood by those skilled in the art. For example, the user 112 can enter a keyword relating to a topic and a filter to exclude certain items from the search results. For example, the user 112 may specify a conversations filter, which in some configurations may cause the search processor 120 to only return one or more results to the client collaboration application 110 relating to conversations data store 124.

In some configurations, the social collaboration search tool 118 can invoke a search indexer 132. The search indexer 132 can index search results. As used herein, search “indexing” includes the collection, parsing, and storing of data to find social knowledge interactions relevant to the search. The search indexer 132 can create and store one or more indexes of information to assist the search processor 120 in executing the search. The use of the search indexer 132 may, in some configurations, provide a more efficient mechanism for searching various data stores, including the collaboration data store 122 and/or the external conversations data store 128. Further, in some configurations, the social collaboration search tool 118 can sort search results and provide, to the collaboration application 108, social collaboration search results in a vertical search format. As used herein, a “vertical search format” includes search results that focus on a specific segment of information. In various configurations described herein, a vertical search format provides search results that are focused on information relating to social collaborations, as defined herein.

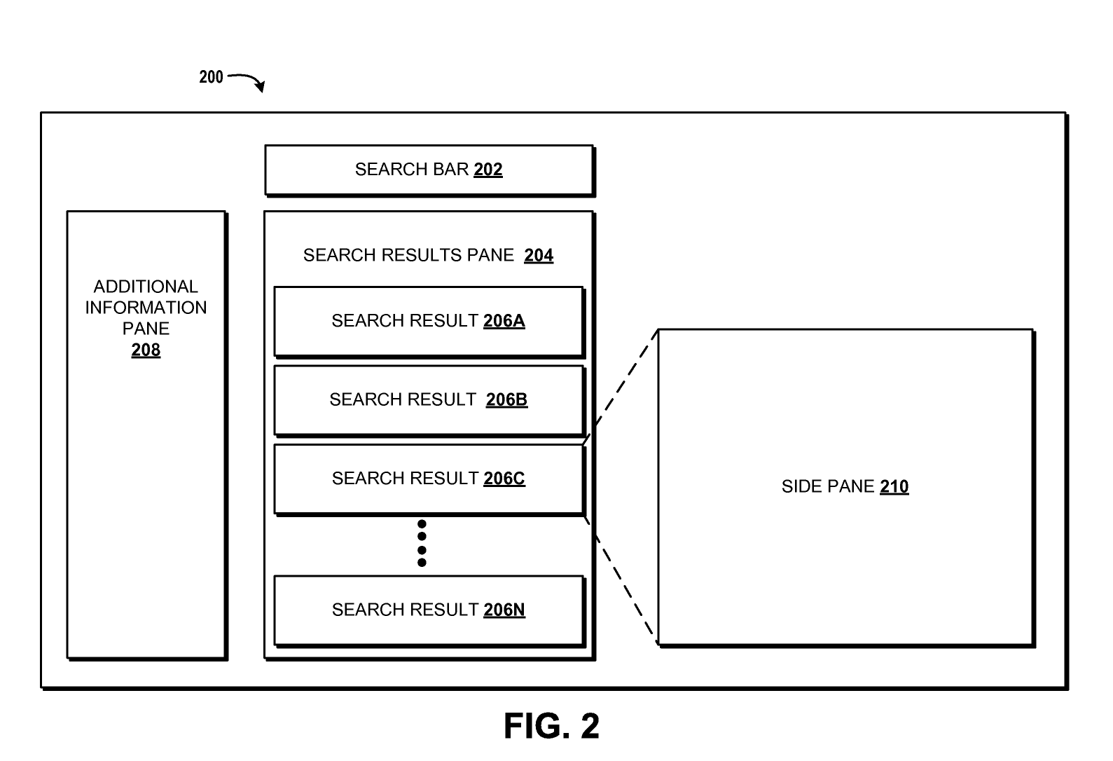

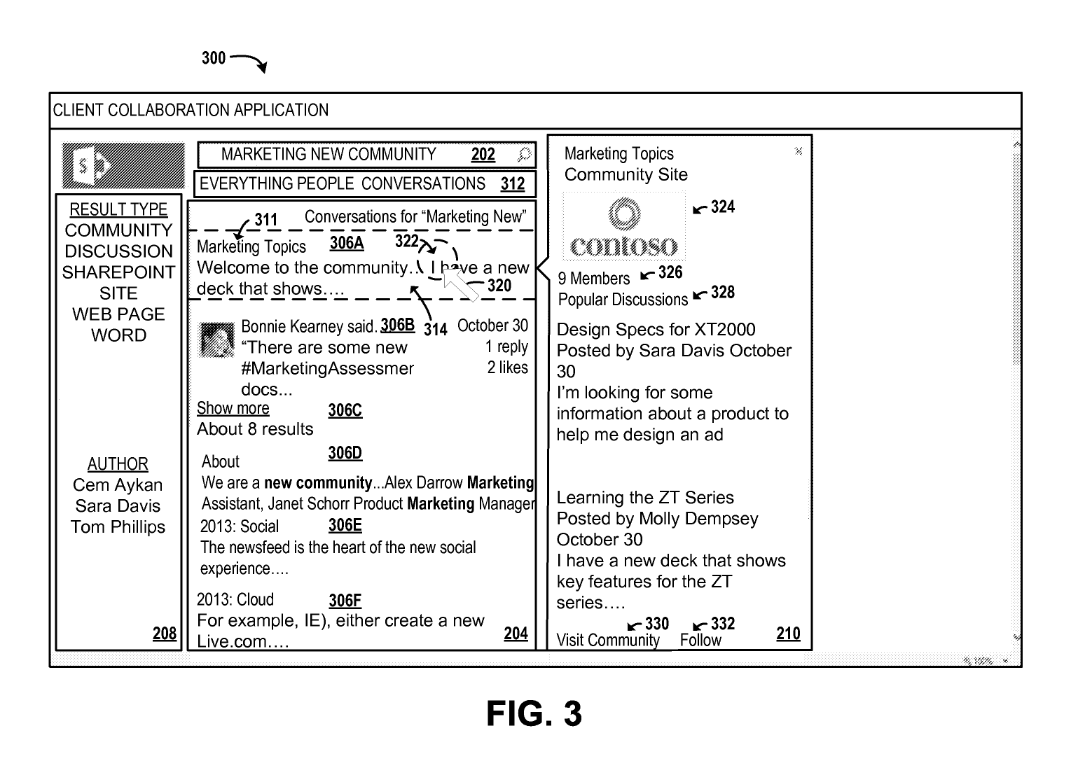

FIG. 2 illustrates an exemplary search UI 200 that can be generated by the social collaboration search tool 118 and displayed by the client collaboration application 110 on the display 114 of the client device 102. The search UI 200 includes a search bar 202. The search bar 202 can receive and display search terms for execution by the search processor 120. For example, from the search bar 202, the search UI 200 can receive one or more search terms entered by the user 112. When a search processor 120 executes a search, the results of the search can be returned for display in the search UI 200 in a search results pane 204. The search results pane 204 can display one or more search results, illustrated as search results 206A-206N (hereinafter collectively and/or generically referred to as “search results 206”). The search results 206 can include information retrieved from various sources, including the collaboration data store 122 and/or the external conversations data store 128. Examples of the search results 206 are provided in FIGS. 3-7, below.

The search UI 200 can include an additional information pane 208. The additional information pane 208 can present information relating to the search or the search results 206. For example, and not by way of limitation, the additional information pane 208 can include a listing of names associated with the search results 206. In another example, the additional information pane 208 can include various filters that can be applied to the search results 206 to narrow the scope of the search results 206. It should be appreciated that the concepts and technologies disclosed herein are not limited to the use of the additional information pane 208. It should be further appreciated that the concepts and technologies disclosed herein are not limited to any information or operators (such as filters) that may be included or displayed in the additional information pane 208.

The search UI 200 can also include a side pane 210. In some configurations, the side pane 210 can display information relating to a particular search result of the search results 206. In the example illustrated in FIG. 2, the side pane 210 is displaying information relating to the search result 206C (the relationship illustrated in FIG. 2 by way of dashed lines). The side pane 210 can include information relating to the search result 206C that may not be displayed in the search results pane 204. For example, the search result 206C may relate to a particular discussion that includes a topic and one or more replies. To display that amount of information in the search results pane 204 may, in some instances, be visually disruptive and can reduce the amount of information capable of being displayed for the other results in the search results 206. Thus, in some configurations, the side pane 210 can be invoked to display information relating to a particular search result.

For example, the side pane 210 may be displayed if a selection device, such as a mouse cursor or tactile input (such as a finger) is placed in a location in or near the search result 206C. In another example, the side pane 210 may be invoked based on certain criteria and without input from the user 112. For example, the side pane 210 may be invoked to display the first search result. The concepts and technologies disclosed herein are not limited to any manner in which the side pane 210 is invoked. As described above, the search processor 120 may receive search terms to search one or more data stores having social knowledge interactions stored thereon, such as the collaboration data store 122 and/or the external conversations data store 128. In some configurations, if no operators, filters or other search limiting criteria are received by the search processor 120, the search processor 120 executes a “global”, or unlimited, search.

FIG. 3 is a UI diagram showing a global conversations search UI 300 displaying the search results pane 204, which is the result of a search executed by the search processor 120 for the client collaboration application 110. In the example illustrated in FIG. 3, the user 112 has entered a search in the search bar 202 for “marketing new community.” The search results pane 204 may display results 306A-306F of the search (hereinafter collectively and/or generically referred to as “search results 306”). In accordance with various concepts and technologies disclosed herein, the search results 306 can be conversations relating to the search, “marketing new community.” The search processor 120 can execute a search on one or more data stores, such as the collaboration data store 122 and/or the external conversations data store 128.

As illustrated, the search results 306 can vary depending on the information retrieved by the search processor 120. For example, and not by way of limitation, the search results 306 displayed in the search results pane 204 are: search result 306A, which is a marketing topic; search result 306B, which relates to a discussion involving a specific person; search result 306C, which is a query to show more results; search result 306D, which is information about a community; search result 306E, which is information about a social aspect of a newsfeed; and search result 306F, which is information about a specific product. It should be appreciated that the concepts and technologies described herein are not limited to any type of search results 306.

In the example illustrated in FIG. 3, the search result 306A includes a title 311, “Marketing Topics,” and a brief description 314 of the search result 306A. It should be appreciated that the information displayed in the search results 306 is illustrative and should not be interpreted as an intent to limit the scope of the concepts and technologies disclosed herein. In some configurations, the search result 306A can include one or more discussions that are the most active. The social collaboration search tool 118 can be configured to sort the search results 306 to surface the most active discussion as the first result (the search result 306A) of the search results 306. As used herein, “active” includes a relatively high level of activity associated with a discussion, post, or conversation when compared to other discussions, posts, or conversations. As used herein, “activity” includes views of a discussion, the number of replies to a discussion, the number of times the discussion has been posted to other communities, etc. The concepts and technologies disclosed herein are not limited to any particular type of activity.

The client collaboration application 110 can receive an input that the user 112, or other entity, desires to narrow a scope of the search results 306. The client collaboration application 110 can display various filters or operators in one or more panes for receiving input from the user 112. In one configuration, the client collaboration application 110 can display a filter bar 312. The filter bar 312 can display one or more categories to filter the search results 306. In the configuration of FIG. 3, the categories are “Everything,” “People,” and “Conversations.” The client collaboration application 110 can receive an input to narrow the search results to a specified or desired category type. For example, the client collaboration application 110 can receive an input that the user 112 selected “People,” causing, in some configurations, the search processor 120 to narrow the scope of the search results 306 to only results relating to “People”.

The client collaboration application 110 may present other filters for receiving input from the user 112 to narrow the scope of the search results 306. In one configuration, the client collaboration application 110 can display an additional information pane 208. The additional information pane 208 can present the user 112 with additional filters or operators that the user 112 may select to refine a search presented in the search results pane 204.

In other configurations, the additional information pane 208 can present the user 112 with hyperlinks, or links, to information not displayed in the search results 306. In some configurations, the additional information pane 208 can be displayed in conjunction with or as an alternative to the filter bar 312. It should be understood that providing various filters or operators in one or more panes, such as the filter bar 312 and the additional information pane 208, is illustrative only and may be implemented in various ways. For example, all filters may be presented in a single pane. The concepts and technologies disclosed herein are not limited to any particular configuration.

The client collaboration application 110 may present the side pane 210. The side pane 210 can display additional information relating to a particular search result of the search results 306. The side pane 210 can be invoked by the client collaboration application 110 based on various inputs or conditions. For example, the client collaboration application 110 can display the side pane 210 by default with the display of the search results pane 204. In another configuration, the client collaboration application 110 can display the side pane 210 when an input is received from the user 112 or other entity. In one example, the client collaboration application 110 can detect that a selection device 320 is located at location 322. In this configuration, the location 322 corresponds to a location on or near the search result 306A. In this configuration, the client collaboration application 110 can display the side pane 210, which includes additional information relating to the search result 306A. The concepts and technologies disclosed herein are not limited to any particular selection device 320 or input mechanism. For example, the selection device 320 can include a mouse pointer, a finger of the user 112, a stylus pen, or other tactile input.

As described above, the side pane 210 may present additional information related to the search result 306A. In the example illustrated in FIG. 3, the side pane 210 can include information such as a company name 324, a number of members 326 in a particular community associated with the search result 306A, and popular discussions 328 in the community associated with the search result 306A. In order to build upon the social aspect of the present disclosure, wherein the user 112 is collaboratively connected to other individuals or groups in some manner, the side pane 210 may also be configured with links to provide the user 112 with various functionalities. In the example illustrated in FIG. 3, for instance, the user 112 may be able to select a community link 330 to have a site associated with a community relating to the search result 306A displayed. In some configurations, the side pane 210 may also display a follow link 332, which when selected, can allow the user 112 to follow a community relating to the search result 306A.

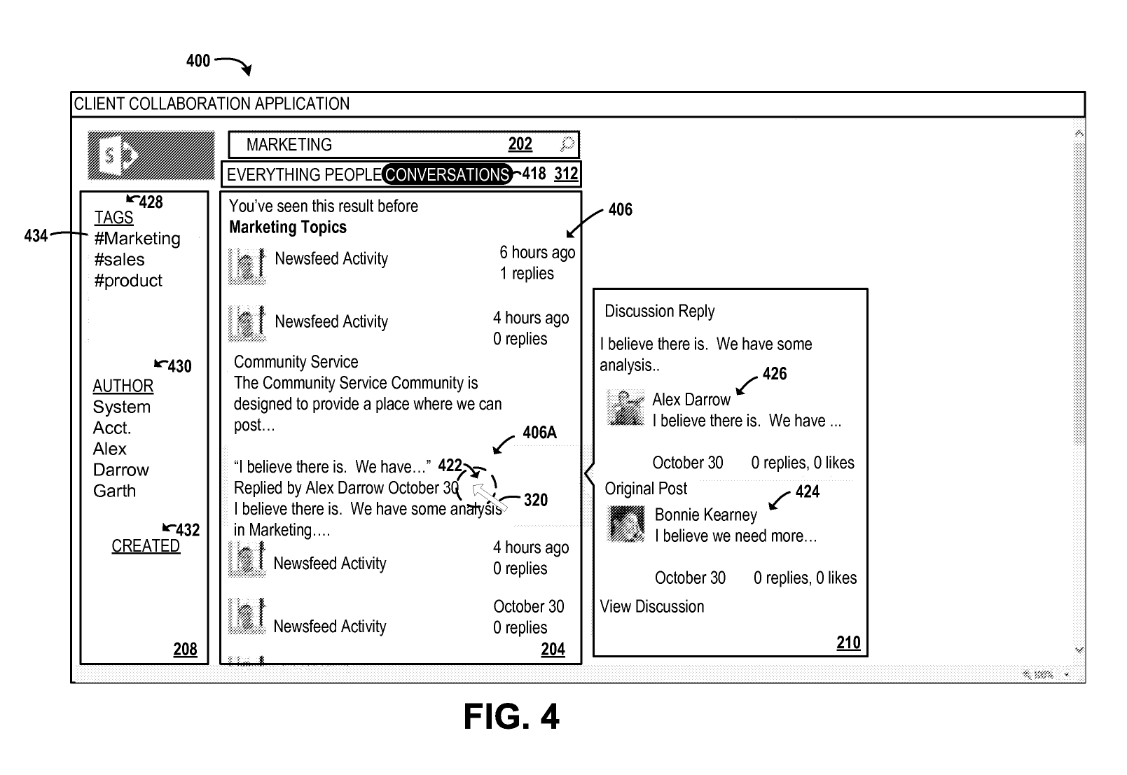

As previously discussed, the user 112 may be allowed to narrow or filter the search results 306 to specific categories. FIG. 4 is a UI diagram showing a search UI 400 displaying the search results pane 204. The search results pane 204 is the result of a search executed by the search processor 120 for the client collaboration application 110. In the configuration illustrated in FIG. 4, the client collaboration application 110 receives an input in the search bar 202 to search for “MARKETING”. To narrow the scope of the search, the search processor 120 can receive one or more filters or operators. The client collaboration application 110 displays the search results pane 204 when the search processor 120 returns results relating to a search for “MARKETING”. The search results pane 204 displays search results 406. The search results 406 can be filtered using the filter operator 418 relating to “Conversations.” By receiving an input to filter the search results 406 using the filter operator 418, the search processor 120 can limit the scope of the search to information relating to conversations.

The user 112 can also be presented with additional information in some embodiments. In the configuration illustrated in FIG. 4, for example, the side pane 210 can be displayed when the client collaboration application 110 receives an input that a selection device 320 is located at location 422. In this configuration, the location 422 corresponds to the search result 406A of the search results 406. The side pane 210 has displayed therein an original post 424 and a reply 426 to the original post 424. Thus, the social interaction between the drafter of the original post 424 and a person that submitted the reply 426 can be viewed by the user 112. In some configurations, the original post 424 and the reply 426 to the original post 424 can be termed a conversation. In some configurations, the reply 426 to the original post 424 can be the most recent reply to the original post 424.

In some configurations, the user 112 may be presented with still further information relating to the search results 406. In one example, the additional information pane 208 is displayed. Displayed in the additional information pane 208 are a tag section 428, an author section 430 and a created section 432. In some configurations, the tag section 428 lists one or more hashtags, or other metadata, associated with one or more conversations. The tag section 428 can present a listing of hashtags, or other metadata. In some configurations, a hashtag may be used by an individual or other entity to associate a particular conversation with a particular phrase. For example, hashtag 434 is “#MarketingCommunications.” When selected by the user 112, the search processor 120 can narrow the search results 406 to conversations that have been associated with the phrase, “MarketingCommunications,” which has been associated with the hashtag 434.

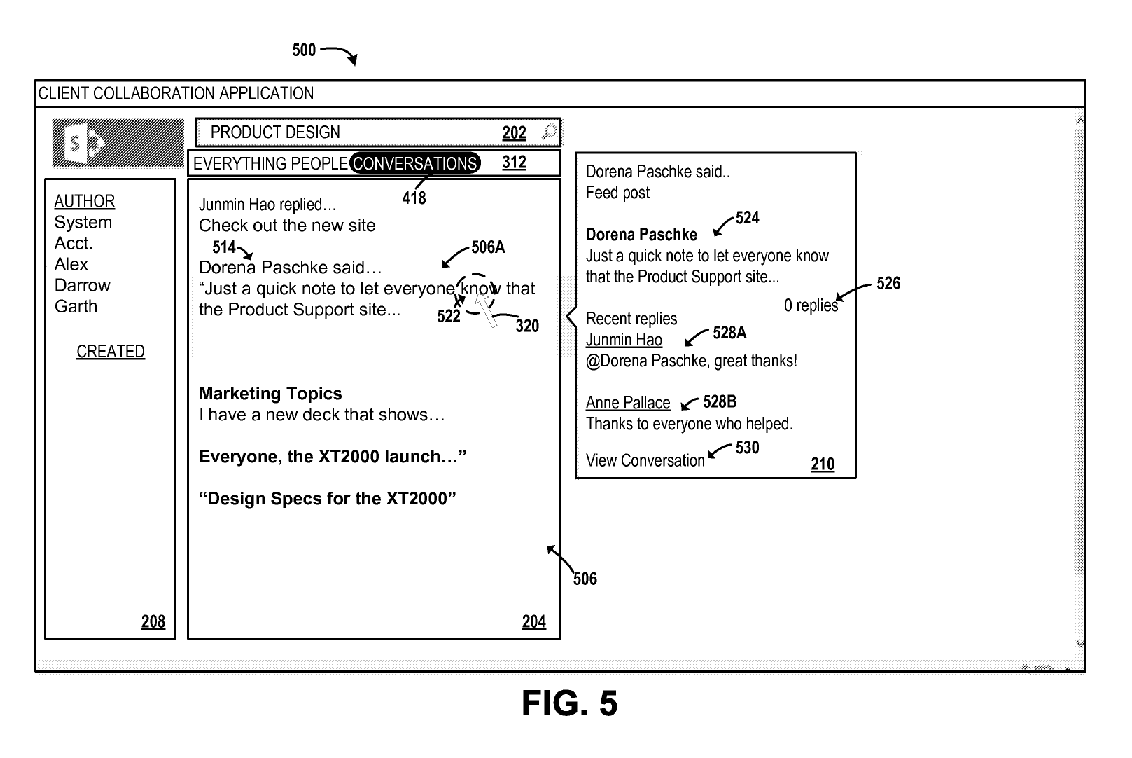

FIG. 5 is a UI diagram showing an alternative search UI 500. The search UI 500 can be displayed by the client collaboration application 110 when the client collaboration application 110 receives an input from the search bar 202 to search for the phrase “product design”. In this configuration, the client collaboration application 110 receives an input to narrow the scope of the search to “Conversations” vis-à-vis the selection of the filter operator 418, corresponding to “Conversations,” from the filter bar 312. In this configuration, the search processor 120 receives the input in the search bar 202 and the filter operator 418. The search processor 120 executes a search and provides the search results 506 to the client collaboration application 110 for display in the search result pane 204. In the configuration illustrated in FIG. 5, the search results 506 include a search result 506A. The search result 506A includes information regarding a statement made by an individual 514. The search result 506A displays a summary of the statement. The client collaboration application 110 can invoke the side pane 210 when an input is received that the selection device 320 is located at location 522.

The side pane 210 can display information relating to the search result 506A. Displayed in side pane 210 is an original post 524 submitted by the individual 514. Along with the original post 524, the side pane 210 also displays information related 526 to the original post 524, such as the number of replies and any feedback given to the author regarding the post. The side pane 210 also displays replies 528A and 528B to the original post 524. The client collaboration application 110 may display more information relating to the original post 524 if the client collaboration application 110 receives an input, such as a selection input on the search result 506A. In another configuration, the client collaboration application 110 can display more information relating to the original post if the client collaboration application 110 receives an input that a view conversation link 530 has been selected. It should be appreciated that various technologies may be used by the client collaboration application 110 to display additional information.

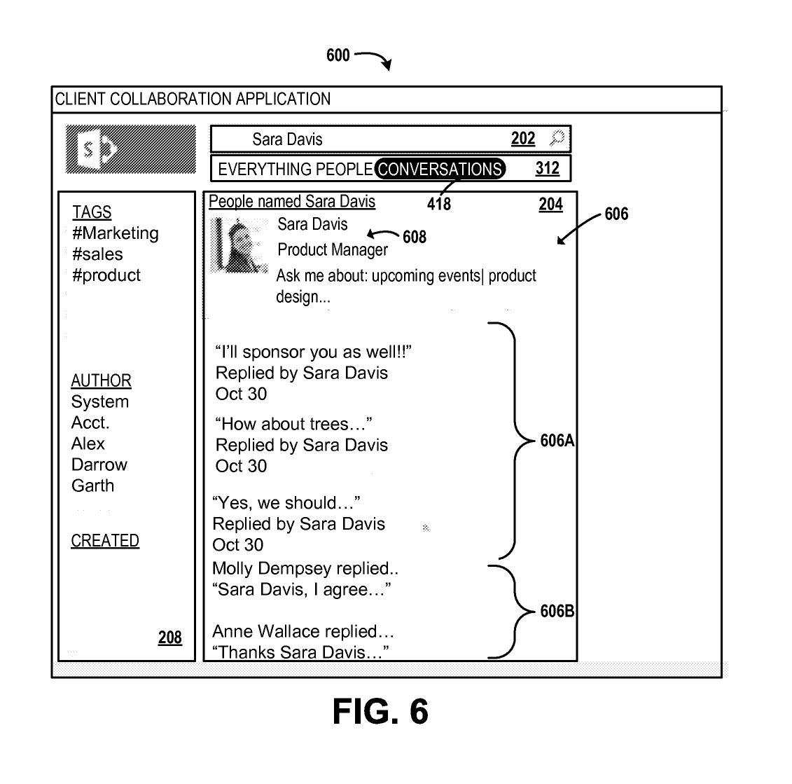

Various concepts and technologies described herein can provide a user with the ability to focus on conversations involving a specific individual. FIG. 6 is a UI diagram showing a person-specific search UI 600. In FIG. 6, the client collaboration application 110 has received an input in the search bar 202 to search for an individual named “Sara Davis.” Further, the client collaboration application 110 has received an input to filter the results of the search to “Conversations” from an input received by a selection of the filter operator 418 in the filter bar 312. The client collaboration application 110 displays the search results pane 204 which includes search results 606.

As illustrated, the search results 606 include results that involve the individual named “Sara Davis” in some manner. In the configuration illustrated in FIG. 6, the search results 606 include profile information 608 for an individual named “Sara Davis,” the focus of the search. The profile information 608 can include, but is not limited to, the individual's name, a title, an address, an email address, and/or a phone number. Further, in the configuration illustrated in FIG. 6, the search results 606 include search results 606A that are replies by “Sara Davis” to various posts made by other individuals. Additionally in the configuration illustrated in FIG. 6, the search results 606 include search results 606B that are replies from various individuals to “Sara Davis.” Additional information pane 208 may provide additional information or additional filters that the user can interact with to further narrow the search.

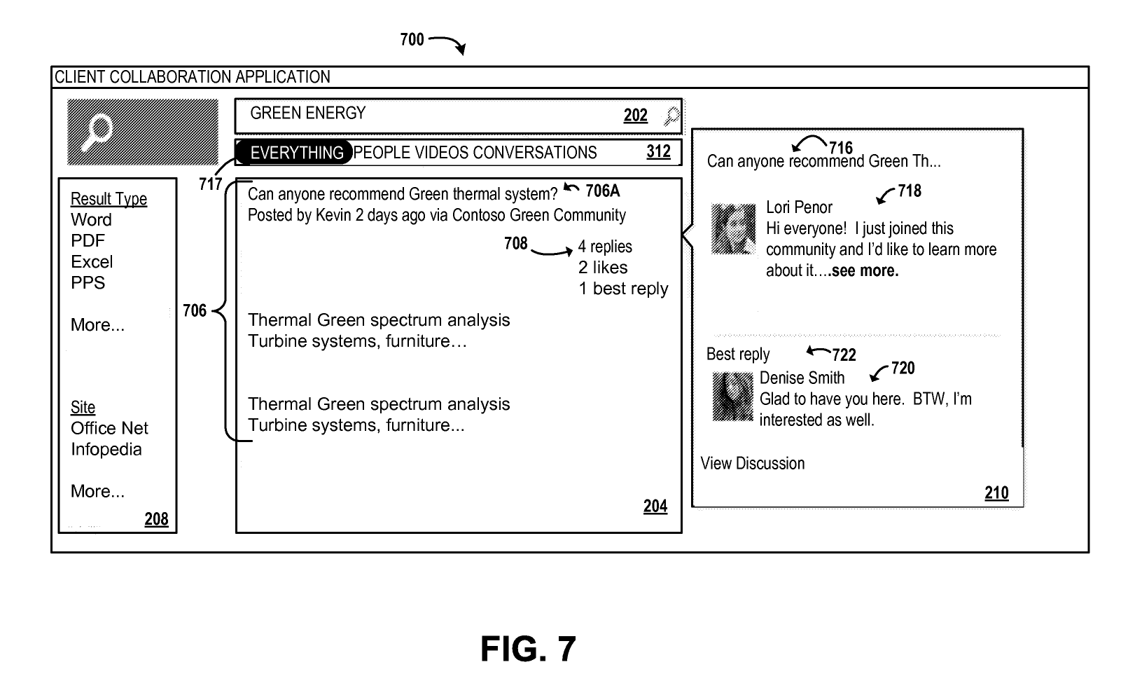

In addition to determining more information about a specific author, as illustrated by way of example, in FIG. 6, the user 112 may want to know more information about a specific conversation or receive additional information regarding post or replies to the conversation. FIG. 7 is a UI diagram showing a conversation specific search UI 700. In FIG. 7, the client collaboration application 110 has received an input that the user 112 or other entity desires to view additional information regarding a conversation. The client collaboration application 110 has received a search input for “Green Energy” in the search bar 702. Search results 706 are displayed in the search results pane 204. Further, the filter operator 717, corresponding to a filter for “Everything,” is selected. In this configuration, the search processor 120 performs a global search.

Additional information regarding search result 706A of the search results 706 is displayed in the side pane 210. The search result 706A has displayed therein additional conversation information 708. In this example, the additional conversation information 708 includes a number of replies to the conversation topic of search result 706A, the number of “likes” given to either the topic or any replies to the topic of the search result 706A, and an indication that a best reply has been noted to the topic of the search result 706A. It should be understood that the additional conversation information 708 may have various types of information not explicitly illustrated in FIG. 7.

The side pane 210 displays additional information regarding the search result 706A. As illustrated, a topic 716 (“Can anyone recommend Green thermal system?”) of the search result 706A is displayed along with an original post 718 of the topic 716 and a reply 720 to the original post 718. In addition, the reply 720 is annotated as a “best reply” 722 to the original post 718. It should be noted that various technologies may be used to determine which reply is a “best reply” 722, including, but not limited to, a designation by an individual involved in the conversation, a voting mechanism used by a community, etc.

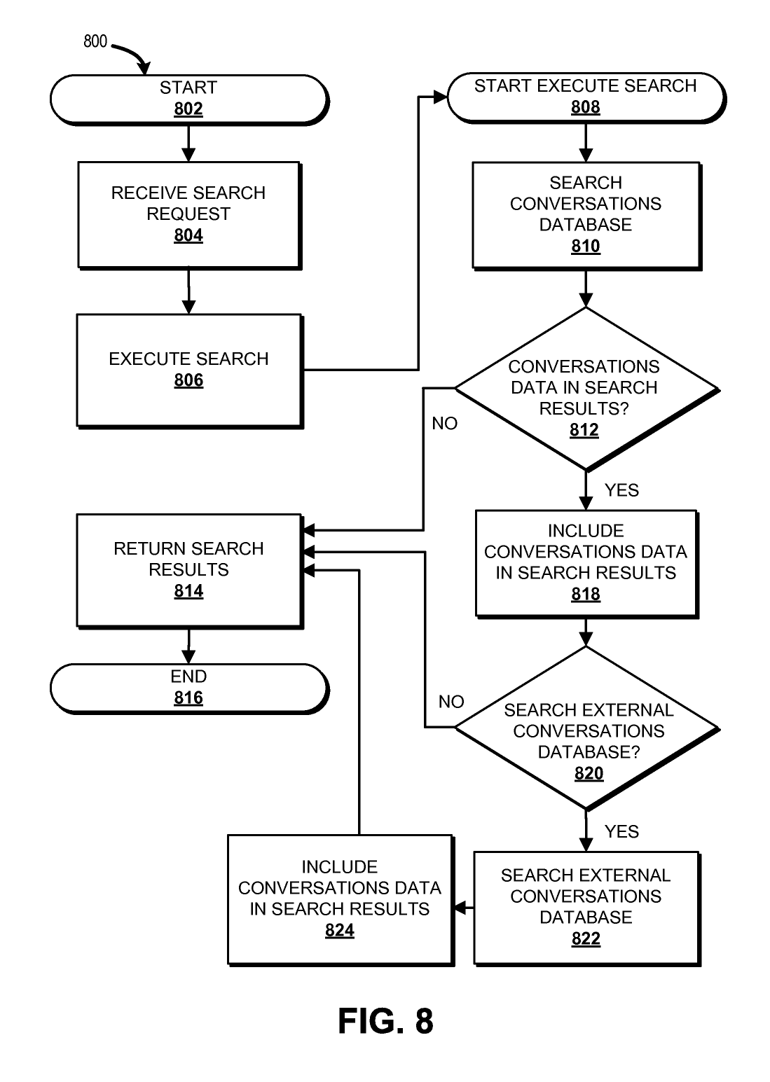

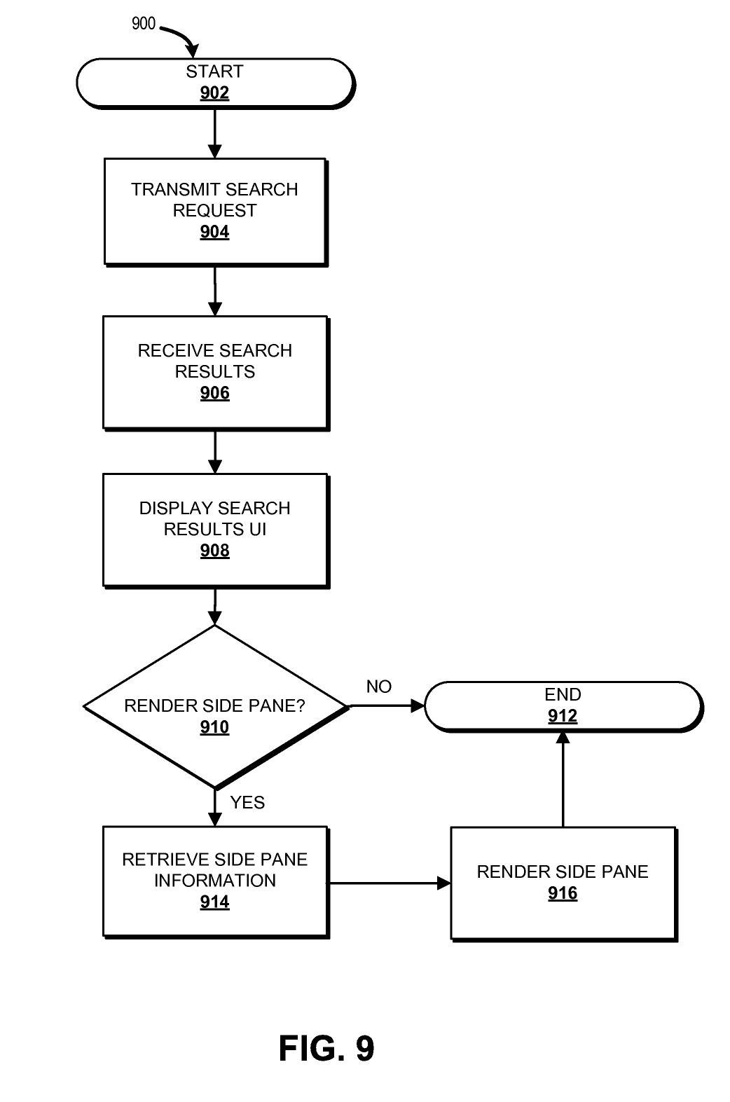

Turning now to FIGS. 8 and 9, aspects of methods for searching for social knowledge interactions within a collaborative environment are illustrated, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

The operations of the methods are described herein below as being implemented, at least in part, by the client collaboration application 110, the collaboration application 108, or combinations thereof. One or more of the operations of the methods may alternatively or additionally be implemented, at least in part, by the similar components in either the client device 102 and/or the enterprise computing device 114.

Turning to FIG. 8, the method 800 begins at operation 802 and proceeds to operation 804, where the collaboration application 108 executing on the enterprise computing device 104 receives a search request from the client collaboration application 110 executing on the client device 102. It should be appreciated that the concepts and technologies described herein are not limited to any particular mechanism for executing a search request. The method 800 described herein below discloses a configuration in which a filter or other mechanism is received that causes the search processor 120 to narrow the search request query to the conversations data store 124. In another configuration, the social collaboration search tool 118 may receive a global search query to search other data stores (not illustrated) in addition to the collaboration data store 122 and/or the external conversations data store 128.

In another configuration, the social collaboration search tool 118 may have logic that can determine if the search query should focus the search on the conversations data store 124, even if the search query does not have a filter or other mechanism selected and input by the user 112. For example, the search query may include certain terms, such as, but not limited to, “question,” “forum,” “post,” “question,” and/or “community,” that the logic recognizes as terms that should focus the search on the conversations data store 124. In another example, the social collaboration search tool 118 may have logic that recognizes that prior users selected conversation-related search results when using similar search terms as the terms used in a current search query. In some configurations, when a conversation-related search request is not explicitly received through the use of filters or other scope narrowing mechanisms, but the social collaboration search tool 118 logic has determined that conversation-related search results may be applicable, the collaboration application 108 may be configured to have rendered in the search results page 130 an additional search results pane that includes only the conversation-related search results.

In some configurations, the search request can include one or more terms to search and/or one or more filters to narrow the scope of the search or narrow the search results returned to the client collaboration application 110. In some configurations, the collaboration application 108 can be configured to search for conversations in one or more data stores without an instruction to search for conversations. In other configurations, the collaboration application 108 can be configured to search for conversations in one or more data stores after receipt of an instruction to search for conversations from another component, such as the client collaboration application 110.

From operation 804, the method 800 proceeds to operation 804, where the collaboration application 108 transmits the search request to the social collaboration search tool 118. The social collaboration search tool 118 receives the search request and invokes the search processor 120 to execute the search on various data stores, such as the collaboration data store 122.

From operation 806, the method 800 proceeds to operation 808, where the search request including a request for conversation information is commenced. It should be appreciated that the concepts and technologies disclosed herein are not limited to searching in data store that include only conversations information. From operation 808, the method 800 proceeds to operation 810, where the search processor 120 executes the search request in the conversations data store 124. It should be appreciated that the concepts and technologies described herein are not limited to any specific mechanism for searching at operation 810. In one configuration, a search can use the search indexer 132. For example, the social collaboration search tool 118 can invoke the search indexer 132 to search for and index relevant information from various data stores, such as the conversations data store 124. The information is collected and indexed by the search indexer 132. In this configuration, when a search is executed, the search processor 120 can access the collected and indexed information provided by the search indexer 132 and return those results. In another configuration, the search processor 120 can access various data stores, such as the conversations data store 124, directly.

A determination is made as to whether or not the conversations data store 124 includes conversations data relating to the search request. If the executed search on the conversations data store 124 does not include conversations data, the search result is returned to the collaboration application at operation 814. From operation 814, the method 800 proceeds to operation 816, where it ends.

If the search results on the conversations data store 124 includes conversations data, the conversations data is included in the search results. In some configurations, the search processor 120 may be configured to search external data stores, such as the external conversations data store 128. In that configuration, the method 800 proceeds from operation 812 to 818, where a determination is made as to whether external conversations data stores should be searched, such as the external conversations data store 128. If the search processor 120 does not have instructions to execute a search on the external conversations data store 128, the search results of operation 812 are returned to the search processor at operation 814.

If the search processor 120 has instructions to execute a search on the external conversations data store 128, the method 800 proceeds from operation 820 to 822, where the search processor 120 executes a search on the external conversations data store 128. The method 800 then proceeds from operation 822 to operation 824, where the external conversations data from external conversations data store 128 is added to the conversations data from conversations data store 124. The method 800 proceeds from operation 824 to operation 814, where the search results are returned. The method 800 proceeds from operation 814 to operation 814, where the search operation is ended.

FIG. 9 is a block diagram illustrating an exemplary method for a client-side collaboration application executing a search and displaying the search results. Turning to FIG. 9, the method 900 begins at operation 902 and proceeds to operation 904, where the client collaboration application 110 executing on the client terminal transmits a search request to a collaboration application 108 executing on the enterprise computing device 104. In this configuration of the method 900, the search request includes a request for conversations data. It should be appreciated that a search can be executed using various methods and technologies, including, but not limited to, the concepts and technologies described herein.

The method 900 proceeds from operation 904 to operation 906, where the search results are received by the client collaboration application. In some configurations, if available and relevant to the search as determined by the search parameters used by the component executing the search, the search results include conversations data. The method 900 proceeds from operation 906 to operation 908, where the search results are displayed in the search UI 116. The concepts and technologies described herein are not limited to any particular format for displaying the search results in the search UI. For example, and not by way of limitation, the search results can be displayed in a list format in the search results pane 204. In another example, the search results can include additional information displayed in additional information pane 208.

In a still further configuration, additional information relating to one or more search results can be displayed upon receipt of an input. In that configuration, the method 900 proceeds from operation 908 to operation 910, where a determination is made as to whether or not a side pane is rendered in the search UI 116. Examples of the inputs include, but are not limited to, the placement of the selection device 320 in a location corresponding to a search results, a finger of the user 112, a stylus pen, or other tactile input. If no input is received, the method proceeds from operation 910 to operation 912, where the method 900 ends. If an input is received, the method proceeds from operation 910 to operation 914, where the side pane information to be displayed is retrieved. It should be appreciated that the concepts and technologies disclosed herein are not limited to any particular mechanism for retrieving the side pane information. In one configuration, the side pane information can be retrieved by the social collaboration search tool 118 executing a query on the conversations data store 124. In another configuration, the social collaboration search tool 118 can invoke the search processor 120 to perform a search on information collected by the search indexer 132. The method 900 proceeds from operation 914 to operation 916, where the information retrieved is rendered in a side pane. The method 900 proceeds from operation 916 to operation 912, where the method 900 ends.

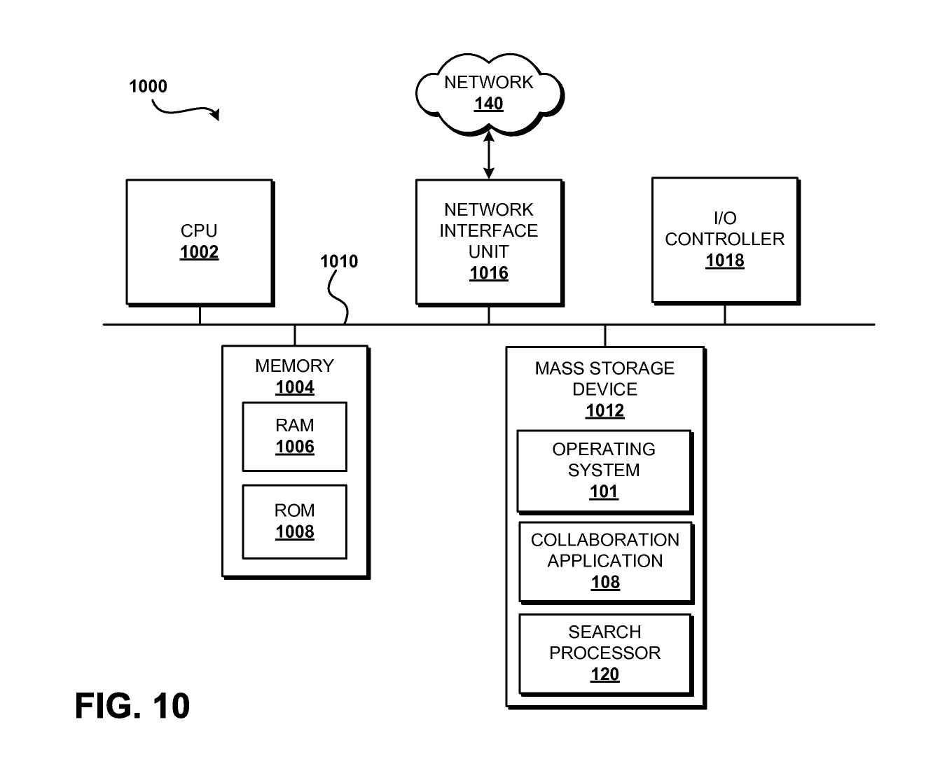

FIG. 10 is a computer architecture diagram showing an illustrative computer hardware and software architecture 1000 for a device capable of executing the software components described herein. Thus, the computer architecture 1000 illustrated in FIG. 10 illustrates an architecture for a server computer, mobile phone, a PDA, a smart phone, a desktop computer, a netbook computer, a tablet computer, and/or a laptop computer. The computer architecture 1000 may be utilized to execute any aspects of the software components presented herein.

The computer architecture 1000 illustrated in FIG. 10 includes a central processing unit (“CPU”) 1002, a system memory 1004, including a random access memory 1006 (“RAM”) and a read-only memory (“ROM”) 1008, and a system bus 1010 that couples the memory 1004 to the CPU 1002. A basic input/output system containing the basic routines that help to transfer information between elements within the computer architecture 1000, such as during startup, is stored in the ROM 1008. The computer architecture 1000 further includes a mass storage device 1012. When utilized to implement the enterprise computing device 104, the mass storage device 1012 may store the operating system 106 from FIG. 1 and one or more application programs including, but not limited to, the collaboration application 108 and the search processor 120.

The mass storage device 1012 is connected to the CPU 1002 through a mass storage controller (not shown) connected to the bus 1010. The mass storage device 1012 and its associated computer-readable media provide non-volatile storage for the computer architecture 1000. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1000.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer architecture 1000. For purposes of the claims, the phrase “computer storage medium,” and variations thereof, does not include waves or signals per se and/or communication media.

According to various embodiments, the computer architecture 1000 may operate in a networked environment using logical connections to remote computers through a network such as the network 140. The computer architecture 1000 may connect to the network 140 through a network interface unit 1016 connected to the bus 1010. It should be appreciated that the network interface unit 1016 also may be utilized to connect to other types of networks and remote computer systems. The computer architecture 1000 also may include an input/output controller 1018 for receiving and processing input from a number of other devices, including a keyboard, mouse, or electronic stylus. Similarly, the input/output controller 1018 may provide an output to a display screen, a printer, or other type of output device.

It should be appreciated that the software components described herein may, when loaded into the CPU 1002 and executed, transform the CPU 1002 and the overall computer architecture 1000 from a general-purpose computing system into a special-purpose computing system customized to facilitate the functionality presented herein. The CPU 1002 may be constructed from any number of transistors or other discrete circuit elements, which may individually or collectively assume any number of states. More specifically, the CPU 1002 may operate as a finite-state machine, in response to executable instructions contained within the software modules disclosed herein. These computer-executable instructions may transform the CPU 1002 by specifying how the CPU 1002 transitions between states, thereby transforming the transistors or other discrete hardware elements constituting the CPU 1002.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this description.

In light of the above, it should be appreciated that many types of physical transformations take place in the computer architecture 1000 in order to store and execute the software components presented herein. It also should be appreciated that the computer architecture 1000 may include other types of computing devices, including hand-held computers, embedded computer systems, personal digital assistants, and other types of computing devices known to those skilled in the art. It is also contemplated that the computer architecture 1000 may not include all of the components shown in FIG. 10, may include other components that are not explicitly shown in FIG. 10, or may utilize an architecture completely different than that shown in FIG. 10.

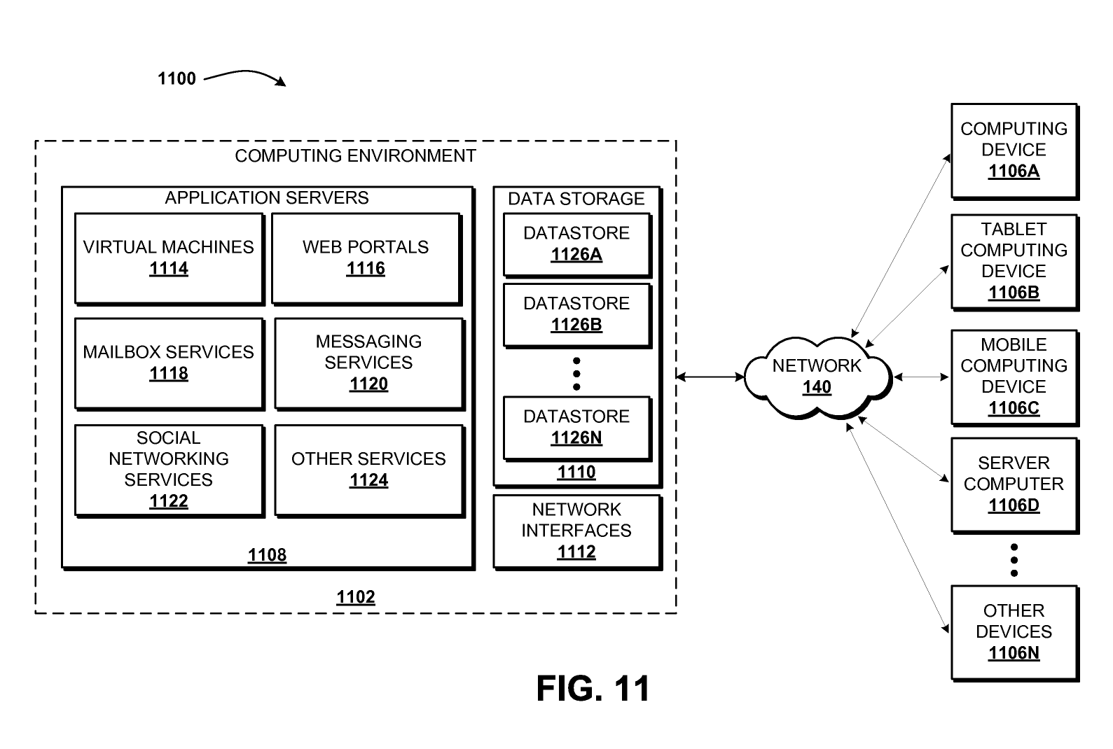

FIG. 11 illustrates an illustrative distributed computing environment 1100 capable of executing the software components described herein for providing the concepts and technologies described herein. Thus, the distributed computing environment 1100 illustrated in FIG. 11 can be used to provide the functionality described herein. The distributed computing environment 1100 thus may be utilized to execute any aspects of the software components presented herein.

According to various implementations, the distributed computing environment 1100 includes a computing environment 1102 operating on, in communication with, or as part of the network 140. The network 140 also can include various access networks. One or more client devices 1106A-1106N (hereinafter referred to collectively and/or generically as “clients 1106”) can communicate with the computing environment 1102 via the network 140 and/or other connections (not illustrated in FIG. 11). In the illustrated embodiment, the clients 1106 include a computing device 1106A such as a laptop computer, a desktop computer, or other computing device; a slate or tablet computing device (“tablet computing device”) 1106B; a mobile computing device 1106C such as a mobile telephone, a smart phone, or other mobile computing device; a server computer 1106D; and/or other devices 1106N. It should be understood that any number of clients 1106 can communicate with the computing environment 1102. It should be understood that the illustrated clients 1106 and computing architectures illustrated and described herein are illustrative, and should not be construed as being limited in any way.

In the illustrated embodiment, the computing environment 1102 includes application servers 1108, data storage 1110, and one or more network interfaces 1112. According to various implementations, the functionality of the application servers 1108 can be provided by one or more server computers that are executing as part of, or in communication with, the network 1104. The application servers 1108 can host various services, virtual machines, portals, and/or other resources. In the illustrated embodiment, the application servers 1108 host one or more virtual machines 1114 for hosting applications or other functionality. According to various implementations, the virtual machines 1114 host one or more applications and/or software modules for providing the functionality described herein for searching for social knowledge interactions. It should be understood that this embodiment is illustrative, and should not be construed as being limiting in any way. The application servers 1108 also host or provide access to one or more Web portals, link pages, Web sites, and/or other information (“Web portals”) 1116.

According to various implementations, the application servers 1108 also include one or more mailbox services 1118 and one or more messaging services 1120. The mailbox services 1118 can include electronic mail (“email”) services. The mailbox services 1118 also can include various personal information management (“PIM”) services including, but not limited to, calendar services, contact management services, collaboration services, and/or other services. The messaging services 1120 can include, but are not limited to, instant messaging services, chat services, forum services, and/or other communication services.

The application servers 1108 also can include one or more social networking services 1122. The social networking services 1122 can include various social networking services including, but not limited to, services for sharing or posting status updates, instant messages, links, photos, videos, and/or other information; services for commenting or displaying interest in articles, products, blogs, or other resources; and/or other services. In some embodiments, the social networking services 1122 are provided by or include the FACEBOOK social networking service, the LINKEDIN professional networking service, the MYSPACE social networking service, the FOURSQUARE geographic networking service, the YAMMER office colleague networking service, and the like. In other embodiments, the social networking services 1122 are provided by other services, sites, and/or providers that may or may not explicitly be known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 1122 also can include commenting, blogging, and/or microblogging services. Examples of such services include, but are not limited to, the YELP commenting service, the KUDZU review service, the OFFICETALK enterprise microblogging service, the TWITTER messaging service, the GOOGLE BUZZ service, and/or other services. It should be appreciated that the above lists of services are not exhaustive and that numerous additional and/or alternative social networking services 1122 are not mentioned herein for the sake of brevity. As such, the above embodiments are illustrative, and should not be construed as being limited in any way.

As shown in FIG. 11, the application servers 1108 also can host other services, applications, portals, and/or other resources (“other resources”) 1124. The other resources 1124 can include, but are not limited to, the collaboration application 108, the search processor 120 and/or the social collaboration search tool 118. It thus can be appreciated that the computing environment 1102 can provide integration of the concepts and technologies disclosed herein provided herein for searching for social knowledge interactions with various mailbox, messaging, social networking, and/or other services or resources. For example, the concepts and technologies disclosed herein can integrated social networking information into various searches and provide those results to a user in conjunction with internal knowledge.

As mentioned above, the computing environment 1102 can include the data storage 1110. According to various implementations, the functionality of the data storage 1110 is provided by one or more databases operating on, or in communication with, the network 140. The functionality of the data storage 1110 also can be provided by one or more server computers configured to host data for the computing environment 1102. The data storage 1110 can include, host, or provide one or more real or virtual datastores 1126A-1126N (hereinafter referred to collectively and/or generically as “datastores 1126”). The datastores 1126 are configured to host data used or created by the application servers 1108 and/or other data. Although not illustrated in FIG. 11, the datastores 1126 also can host or store databases 224A-224N in database 224 shown in FIG. 2.

The computing environment 1102 can communicate with, or be accessed by, the network interfaces 1112. The network interfaces 1112 can include various types of network hardware and software for supporting communications between two or more computing devices including, but not limited to, the clients 1106 and the application servers 1108. It should be appreciated that the network interfaces 1112 also may be utilized to connect to other types of networks and/or computer systems.

It should be understood that the distributed computing environment 1100 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1100 provides the software functionality described herein as a service to the clients 1106. It should be understood that the clients 1106 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1100 to utilize the functionality described herein for searching for social knowledge interactions.

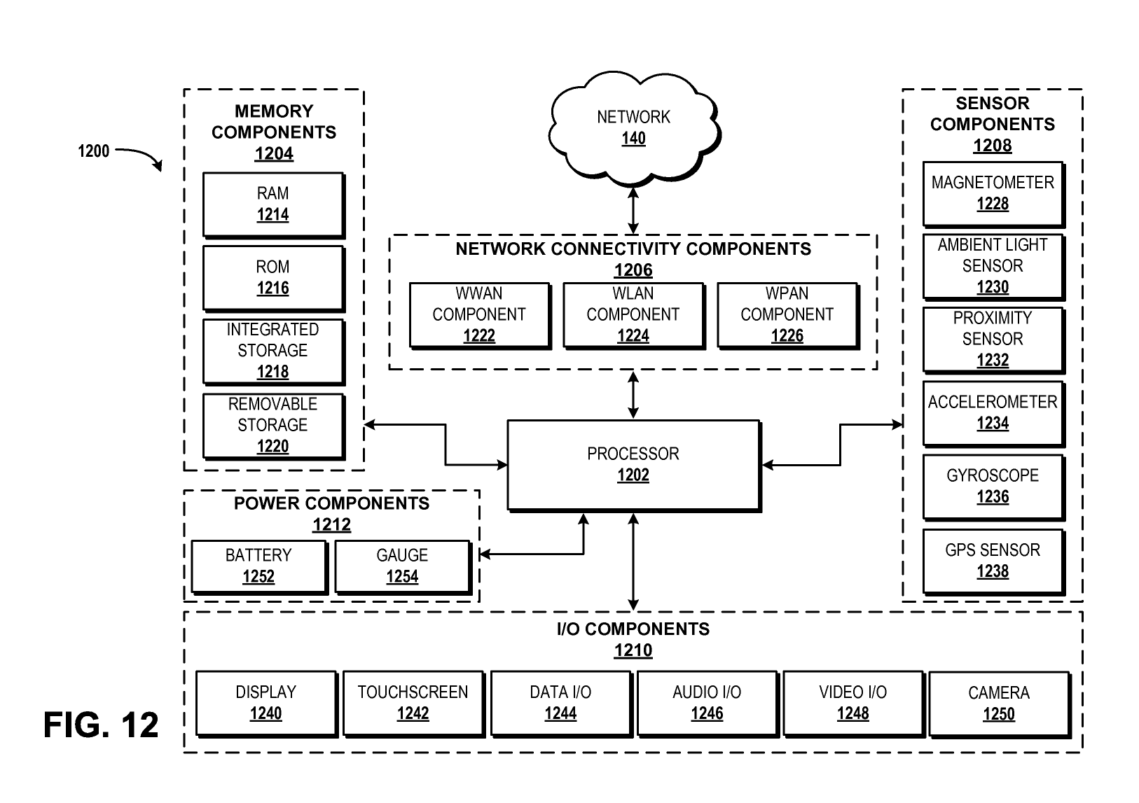

Turning now to FIG. 12, an illustrative computing device architecture 1200 for a computing device that is capable of executing various software components described herein for social collaboration search tool. The computing device architecture 1200 is applicable to computing devices that facilitate mobile computing due, in part, to form factor, wireless connectivity, and/or battery-powered operation. In some embodiments, the computing devices include, but are not limited to, mobile telephones, tablet devices, slate devices, portable video game devices, and the like. Moreover, the computing device architecture 1200 is applicable to any of the clients 1106 shown in FIG. 11. Furthermore, aspects of the computing device architecture 1200 may be applicable to traditional desktop computers, portable computers (e.g., laptops, notebooks, ultra-portables, and netbooks), server computers, and other computer systems, such as described herein with reference to FIG. 1. For example, the single touch and multi-touch aspects disclosed herein below may be applied to desktop computers that utilize a touchscreen or some other touch-enabled device, such as a touch-enabled track pad or touch-enabled mouse.

The computing device architecture 1200 illustrated in FIG. 12 includes a processor 1202, memory components 1204, network connectivity components 1206, sensor components 1208, input/output (“I/O”) components 1210, and power components 1212. In the illustrated embodiment, the processor 1202 is in communication with the memory components 1204, the network connectivity components 1206, the sensor components 1208, the I/O components 1210, and the power components 1212. Although no connections are shown between the individuals components illustrated in FIG. 12, the components can interact to carry out device functions. In some embodiments, the components are arranged so as to communicate via one or more busses (not shown).

The processor 1202 includes a central processing unit (“CPU”) configured to process data, execute computer-executable instructions of one or more application programs, and communicate with other components of the computing device architecture 1200 in order to perform various functionality described herein. The processor 1202 may be utilized to execute aspects of the software components presented herein and, particularly, those that utilize, at least in part, a touch-enabled input.

In some embodiments, the processor 1202 includes a graphics processing unit (“GPU”) configured to accelerate operations performed by the CPU, including, but not limited to, operations performed by executing general-purpose scientific and engineering computing applications, as well as graphics-intensive computing applications such as high resolution video (e.g., 720P, 1080P, and greater), video games, three-dimensional (“3D”) modeling applications, and the like. In some embodiments, the processor 1202 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some embodiments, the processor 1202 is, or is included in, a system-on-chip (“SoC”) along with one or more of the other components described herein below. For example, the SoC may include the processor 1202, a GPU, one or more of the network connectivity components 1206, and one or more of the sensor components 1208. In some embodiments, the processor 1202 is fabricated, in part, utilizing a package-on-package (“PoP”) integrated circuit packaging technique. Moreover, the processor 1202 may be a single core or multi-core processor.

The processor 1202 may be created in accordance with an ARM architecture, available for license from ARM HOLDINGS of Cambridge, United Kingdom. Alternatively, the processor 1202 may be created in accordance with an x86 architecture, such as is available from INTEL CORPORATION of Mountain View, Calif. and others. In some embodiments, the processor 1202 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1204 include a random access memory (“RAM”) 1214, a read-only memory (“ROM”) 1216, an integrated storage memory (“integrated storage”) 1218, and a removable storage memory (“removable storage”) 1220. In some embodiments, the RAM 1214 or a portion thereof, the ROM 1216 or a portion thereof, and/or some combination the RAM 1214 and the ROM 1216 is integrated in the processor 1202. In some embodiments, the ROM 1216 is configured to store a firmware, an operating system or a portion thereof (e.g., operating system kernel), and/or a bootloader to load an operating system kernel from the integrated storage 1218 or the removable storage 1220.

The integrated storage 1218 can include a solid-state memory, a hard disk, or a combination of solid-state memory and a hard disk. The integrated storage 1218 may be soldered or otherwise connected to a logic board upon which the processor 1202 and other components described herein also may be connected. As such, the integrated storage 1218 is integrated in the computing device. The integrated storage 1218 is configured to store an operating system or portions thereof, application programs, data, and other software components described herein.

The removable storage 1220 can include a solid-state memory, a hard disk, or a combination of solid-state memory and a hard disk. In some embodiments, the removable storage 1220 is provided in lieu of the integrated storage 1218. In other embodiments, the removable storage 1220 is provided as additional optional storage. In some embodiments, the removable storage 1220 is logically combined with the integrated storage 1218 such that the total available storage is made available and shown to a user as a total combined capacity of the integrated storage 1218 and the removable storage 1220.

The removable storage 1220 is configured to be inserted into a removable storage memory slot (not shown) or other mechanism by which the removable storage 1220 is inserted and secured to facilitate a connection over which the removable storage 1220 can communicate with other components of the computing device, such as the processor 1202. The removable storage 1220 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1204 can store an operating system. According to various embodiments, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1206 include a wireless wide area network component (“WWAN component”) 1222, a wireless local area network component (“WLAN component”) 1224, and a wireless personal area network component (“WPAN component”) 1226. The network connectivity components 1206 facilitate communications to and from the network 140, which may be a WWAN, a WLAN, or a WPAN. Although a single network 140 is illustrated, the network connectivity components 1206 may facilitate simultaneous communication with multiple networks. For example, the network connectivity components 1206 may facilitate simultaneous communications with multiple networks via one or more of a WWAN, a WLAN, or a WPAN.

The network 140 may be a WWAN, such as a mobile telecommunications network utilizing one or more mobile telecommunications technologies to provide voice and/or data services to a computing device utilizing the computing device architecture 1200 via the WWAN component 1222. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 140 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 140 may be configured to provide voice and/or data communications with any combination of the above technologies. The network 140 may be configured to or adapted to provide voice and/or data communications in accordance with future generation technologies.

In some embodiments, the WWAN component 1222 is configured to provide dual-multi-mode connectivity to the network 140. For example, the WWAN component 1222 may be configured to provide connectivity to the network 140, wherein the network 140 provides service via GSM and UMTS technologies, or via some other combination of technologies. Alternatively, multiple WWAN components 1222 may be utilized to perform such functionality, and/or provide additional functionality to support other non-compatible technologies (i.e., incapable of being supported by a single WWAN component). The WWAN component 1222 may facilitate similar connectivity to multiple networks (e.g., a UMTS network and an LTE network).

The network 140 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some embodiments, the WLAN is implemented utilizing one or more wireless WI-FI access points. In some embodiments, one or more of the wireless WI-FI access points are another computing device with connectivity to a WWAN that are functioning as a WI-FI hotspot. The WLAN component 1224 is configured to connect to the network 140 via the WI-FI access points. Such connections may be secured via various encryption technologies including, but not limited, WI-FI Protected Access (“WPA”), WPA2, Wired Equivalent Privacy (“WEP”), and the like.

The network 140 may be a WPAN operating in accordance with Infrared Data Association (“IrDA”), BLUETOOTH, wireless Universal Serial Bus (“USB”), Z-Wave, ZIGBEE, or some other short-range wireless technology. In some embodiments, the WPAN component 1226 is configured to facilitate communications with other devices, such as peripherals, computers, or other computing devices via the WPAN.

The sensor components 1208 include a magnetometer 1228, an ambient light sensor 1230, a proximity sensor 1232, an accelerometer 1234, a gyroscope 1236, and a Global Positioning System sensor (“GPS sensor”) 1238. It is contemplated that other sensors, such as, but not limited to, temperature sensors or shock detection sensors, also may be incorporated in the computing device architecture 1200.

The magnetometer 1228 is configured to measure the strength and direction of a magnetic field. In some embodiments the magnetometer 1228 provides measurements to a compass application program stored within one of the memory components 1204 in order to provide a user with accurate directions in a frame of reference including the cardinal directions, north, south, east, and west. Similar measurements may be provided to a navigation application program that includes a compass component. Other uses of measurements obtained by the magnetometer 1228 are contemplated.

The ambient light sensor 1230 is configured to measure ambient light. In some embodiments, the ambient light sensor 1230 provides measurements to an application program stored within one the memory components 1204 in order to automatically adjust the brightness of a display (described below) to compensate for low-light and high-light environments. Other uses of measurements obtained by the ambient light sensor 1230 are contemplated.

The proximity sensor 1232 is configured to detect the presence of an object or thing in proximity to the computing device without direct contact. In some embodiments, the proximity sensor 1232 detects the presence of a user's body (e.g., the user's face) and provides this information to an application program stored within one of the memory components 1204 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1232 are contemplated.

The accelerometer 1234 is configured to measure proper acceleration. In some embodiments, output from the accelerometer 1234 is used by an application program as an input mechanism to control some functionality of the application program. For example, the application program may be a video game in which a character, a portion thereof, or an object is moved or otherwise manipulated in response to input received via the accelerometer 1234. In some embodiments, output from the accelerometer 1234 is provided to an application program for use in switching between landscape and portrait modes, calculating coordinate acceleration, or detecting a fall. Other uses of the accelerometer 1234 are contemplated.

The gyroscope 1236 is configured to measure and maintain orientation. In some embodiments, output from the gyroscope 1236 is used by an application program as an input mechanism to control some functionality of the application program. For example, the gyroscope 1236 can be used for accurate recognition of movement within a 3D environment of a video game application or some other application. In some embodiments, an application program utilizes output from the gyroscope 1236 and the accelerometer 1234 to enhance control of some functionality of the application program. Other uses of the gyroscope 1236 are contemplated.

The GPS sensor 1238 is configured to receive signals from GPS satellites for use in calculating a location. The location calculated by the GPS sensor 1238 may be used by any application program that requires or benefits from location information. For example, the location calculated by the GPS sensor 1238 may be used with a navigation application program to provide directions from the location to a destination or directions from the destination to the location. Moreover, the GPS sensor 1238 may be used to provide location information to an external location-based service, such as E911 service. The GPS sensor 1238 may obtain location information generated via WI-FI, WIMAX, and/or cellular triangulation techniques utilizing one or more of the network connectivity components 1206 to aid the GPS sensor 1238 in obtaining a location fix. The GPS sensor 1238 may also be used in Assisted GPS (“A-GPS”) systems.

The I/O components 1210 include a display 1240, a touchscreen 1242, a data I/O interface component (“data I/O”) 1244, an audio I/O interface component (“audio I/O”) 1246, a video I/O interface component (“video I/O”) 1248, and a camera 1250. In some embodiments, the display 1240 and the touchscreen 1242 are combined. In some embodiments two or more of the data I/O component 1244, the audio I/O interface component 1246, and the video I/O component 1248 are combined. The I/O components 1210 may include discrete processors configured to support the various interface described below, or may include processing functionality built-in to the processor 1202.

The display 1240 is an output device configured to present information in a visual form. In particular, the display 1240 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some embodiments, the display 1240 is a liquid crystal display (“LCD”) utilizing any active or passive matrix technology and any backlighting technology (if used). In some embodiments, the display 1240 is an organic light emitting diode (“OLED”) display. Other display types are contemplated.

The touchscreen 1242 is an input device configured to detect the presence and location of a touch. The touchscreen 1242 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen 1242 is incorporated on top of the display 1240 as a transparent layer to enable a user to use one or more touches to interact with objects or other information presented on the display 1240. In other embodiments, the touchscreen 1242 is a touch pad incorporated on a surface of the computing device that does not include the display 1240. For example, the computing device may have a touchscreen incorporated on top of the display 1240 and a touch pad on a surface opposite the display 1240.

In some embodiments, the touchscreen 1242 is a single-touch touchscreen. In other embodiments, the touchscreen 1242 is a multi-touch touchscreen. In some embodiments, the touchscreen 1242 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1242. As such, a developer may create gestures that are specific to a particular application program.

In some embodiments, the touchscreen 1242 supports a tap gesture in which a user taps the touchscreen 1242 once on an item presented on the display 1240. The tap gesture may be used for various reasons including, but not limited to, opening or launching whatever the user taps. In some embodiments, the touchscreen 1242 supports a double tap gesture in which a user taps the touchscreen 1242 twice on an item presented on the display 1240. The double tap gesture may be used for various reasons including, but not limited to, zooming in or zooming out in stages. In some embodiments, the touchscreen 1242 supports a tap and hold gesture in which a user taps the touchscreen 1242 and maintains contact for at least a pre-defined time. The tap and hold gesture may be used for various reasons including, but not limited to, opening a context-specific menu.

In some embodiments, the touchscreen 1242 supports a pan gesture in which a user places a finger on the touchscreen 1242 and maintains contact with the touchscreen 1242 while moving the finger on the touchscreen 1242. The pan gesture may be used for various reasons including, but not limited to, moving through screens, images, or menus at a controlled rate. Multiple finger pan gestures are also contemplated. In some embodiments, the touchscreen 1242 supports a flick gesture in which a user swipes a finger in the direction the user wants the screen to move. The flick gesture may be used for various reasons including, but not limited to, scrolling horizontally or vertically through menus or pages. In some embodiments, the touchscreen 1242 supports a pinch and stretch gesture in which a user makes a pinching motion with two fingers (e.g., thumb and forefinger) on the touchscreen 1242 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1242. As such, the above gestures should be understood as being illustrative and should not be construed as being limiting in any way.

The data I/O interface component 1244 is configured to facilitate input of data to the computing device and output of data from the computing device. In some embodiments, the data I/O interface component 1244 includes a connector configured to provide wired connectivity between the computing device and a computer system, for example, for synchronization operation purposes. The connector may be a proprietary connector or a standardized connector such as USB, micro-USB, mini-USB, or the like. In some embodiments, the connector is a dock connector for docking the computing device with another device such as a docking station, audio device (e.g., a digital music player), or video device.

The audio I/O interface component 1246 is configured to provide audio input and/or output capabilities to the computing device. In some embodiments, the audio I/O interface component 1244 includes a microphone configured to collect audio signals. In some embodiments, the audio I/O interface component 1244 includes a headphone jack configured to provide connectivity for headphones or other external speakers. In some embodiments, the audio I/O interface component 1246 includes a speaker for the output of audio signals. In some embodiments, the audio I/O interface component 1244 includes an optical audio cable out.

The video I/O interface component 1248 is configured to provide video input and/or output capabilities to the computing device. In some embodiments, the video I/O interface component 1248 includes a video connector configured to receive video as input from another device (e.g., a video media player such as a DVD or BLURAY player) or send video as output to another device (e.g., a monitor, a television, or some other external display). In some embodiments, the video I/O interface component 1248 includes a High-Definition Multimedia Interface (“HDMI”), mini-HDMI, micro-HDMI, DisplayPort, or proprietary connector to input/output video content. In some embodiments, the video I/O interface component 1248 or portions thereof is combined with the audio I/O interface component 1246 or portions thereof.

The camera 1250 can be configured to capture still images and/or video. The camera 1250 may utilize a charge coupled device (“CCD”) or a complementary metal oxide semiconductor (“CMOS”) image sensor to capture images. In some embodiments, the camera 1250 includes a flash to aid in taking pictures in low-light environments. Settings for the camera 1250 may be implemented as hardware or software buttons.

Although not illustrated, one or more hardware buttons may also be included in the computing device architecture 1200. The hardware buttons may be used for controlling some operational aspect of the computing device. The hardware buttons may be dedicated buttons or multi-use buttons. The hardware buttons may be mechanical or sensor-based.

The illustrated power components 1212 include one or more batteries 1252, which can be connected to a battery gauge 1254. The batteries 1252 may be rechargeable or disposable. Rechargeable battery types include, but are not limited to, lithium polymer, lithium ion, nickel cadmium, and nickel metal hydride. Each of the batteries 1252 may be made of one or more cells.

The battery gauge 1254 can be configured to measure battery parameters such as current, voltage, and temperature. In some embodiments, the battery gauge 1254 is configured to measure the effect of a battery's discharge rate, temperature, age and other factors to predict remaining life within a certain percentage of error. In some embodiments, the battery gauge 1254 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw, and a voltage.

The power components 1212 may also include a power connector, which may be combined with one or more of the aforementioned I/O components 1210. The power components 1212 may interface with an external power system or charging equipment via a power I/O component (not illustrated).

Based on the foregoing, it should be appreciated that concepts and technologies for a social collaboration search tool. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer, comprising:
a processor; and
a computer-readable storage medium in communication with the processor, the computer-readable storage medium comprising computer-executable instructions stored thereupon which, when executed by the processor, cause the processor to
execute a collaboration application,
receive a conversation data search request comprising a request to search for conversations data,
invoke a search processor to execute the conversation data search request on a conversations data store,
receive a search result comprising the conversations data, and
transmit the search result in response to the conversation data search request.

2. The computer of claim 1, wherein the conversations data search request further comprises a keyword, an operator, or a filter.

3. The computer of claim 1, wherein the conversations data store comprises discussions, newsfeed posts, newsfeed replies, and people records.

4. The computer of claim 3, wherein the discussions comprise at least one discussion and at least one reply to the at least one discussion.

5. The computer of claim 4, wherein the at least one reply is a best reply to the at least one discussion.

6. The computer of claim 4, wherein the at least one reply is a most recent reply to the at least one discussion.

7. The computer of claim 3, wherein the discussions comprises a most active discussion.

8. The computer of claim 7, further comprising instructions to surface the most active discussion as a first search result of the search result.

9. The computer of claim 3, wherein the discussions further comprise at least one metadata tag.

10. The computer of claim 9, wherein the metadata tag comprises a hashtag.

11. The computer of claim 3, wherein the people records comprise a profile picture of at least one individual, a contact information of the at least one individual, a department in which the at least one individual works, at least one group to which the at least one individual belongs, at least one reply posted by the at least one individual, or at least one discussion topic posted by the at least one individual.

12. The computer of claim 1, wherein the conversations data store comprises information relating to at least one community within an organization.

13. A method, comprising:
executing server collaboration application,
receiving a conversation data search request comprising a request to search for conversations data,
transmitting at least one search result comprising the conversations data in response to the conversations data search request for display in a search results pane,
transmitting additional information for display in an additional information pane, the additional information comprising information relating to the at least one search result, and
transmitting information relating to a search result of the at least one search result for display in a side pane.

14. The method of claim 13, wherein the conversation data search request further comprises a keyword, an operator, or a filter.

15. The method of claim 13, wherein the information relating to the search results comprises at least a name of an individual associated with the search results, one or more filters for narrowing the scope of the search results, one or more hyperlinks relating to information not displayed in the search results, or one or more metadata tags associated with at least one discussion of the at least one search result.

16. The method of claim 15, wherein the metadata tag comprises a hashtag.

17. The method of claim 15, wherein the information relating to the search result of at least one search result comprises a discussion topic and one or more replies to the discussion topic.

18. A computer-readable storage medium having computer-executable instructions stored thereupon which, when executed by a computer, cause the computer to:
execute a server collaboration application;
receive a conversation data search request comprising a request to search for conversations data;
invoke a search processor to execute the conversation data search request;
execute the conversation data search request on a conversations data store comprising discussions, newsfeed posts, newsfeed replies, or people records;
receive a plurality of search results comprising the conversations data;
index the plurality of search results; and
transmit the plurality of search results in response to the conversation data search request.

19. The computer-readable storage medium of claim 18, wherein the computer-executable instructions invoke a search processor to execute the search for conversations data further comprises computer-executable instructions which, when executed by the computer, cause the search processor to execute the search for conversations data on an external conversations data store.

20. The computer-readable storage medium of claim 19, wherein the computer-executable instructions invoke a search processor to index the plurality of search results further comprises computer-executable instructions which, when executed by the computer, cause the search processor to sort the plurality of search results in a vertical search format.
